(19) United States
(12) Patent Application Publication
(10) Pub. No.: US 2026/0142458 A1
(43) Pub. Date: May 21, 2026

(54) POWER SUPPLY RESTORATION METHOD AND APPARATUS FOR POWER GRID CLUSTER, STORAGE MEDIUM, AND ELECTRONIC DEVICE

(71) Applicants: GUANGDONG POWER GRID CO., LTD, Guangzhou (CN); ZHUHAI POWER SUPPLY BUREAU GUANGDONG POWER CO., LTD, Zhuhai (CN)

(72) Inventors: Jiangang LU, Guangzhou (CN); Ruifeng ZHAO, Guangzhou (CN); Zufeng HOU, Zhuhai (CN); Guanxin QIU, Zhuhai (CN); Anying CAO, Zhuhai (CN); Kaiyan PAN, Yantai (CN); Haixin LIU, Yantai (CN)

(73) Assignees: GUANGDONG POWER GRID CO., LTD, Guangzhou (CN); ZHUHAI POWER SUPPLY BUREAU GUANGDONG POWER CO., LTD, Zhuhai (CN)

(21) Appl. No.: 19/437,971

(22) Filed: Dec. 31, 2025

Related U.S. Application Data
(63) Continuation of application No. PCT/CN2024/100889, filed on Jun. 24, 2024.

(30) Foreign Application Priority Data
Mar. 25, 2024 (CN) 202410345438.7

(51) Int. Cl. H02J 3/001; H02J 3/48; H02J 3/50; H02J 103/35

(52) U.S. Cl. CPC H02J 3/001; H02J 3/48; H02J 3/50; H02J 2103/35

(57) ABSTRACT

A power supply restoration method a power grid cluster includes: acquiring a cluster parameter of a target power grid cluster in response to a power supply fault occurred in the target power grid cluster, where the cluster parameter includes at least a node voltage and a node power of each node in the target power grid cluster; constructing a power supply restoration model corresponding to the target power grid cluster based on the cluster parameter, and solving the power supply restoration model to obtain an initial power supply restoration strategy; reconstructing the initial power supply restoration strategy based on an alternating direction method of multipliers to obtain a target power supply restoration strategy; and handling the power supply fault of the target power grid cluster to recover power supply based on the target power supply restoration strategy.

### CROSS-REFERENCE TO RELATED APPLICATIONS

This application is a continuation of International Patent Application No. PCT/CN2024/100889 with a filing date of Jun. 24, 2024, designating the United States, now pending, and further claims priority to Chinese Patent Application No. 202410345438.7 with a filing date of Mar. 25, 2024. The content of the aforementioned applications, including any intervening amendments thereto, is incorporated herein by reference.

### TECHNICAL FIELD

The present disclosure relates to the field of power supply, and in particular to a power supply restoration method and apparatus for a power grid cluster, a storage medium, and an electronic device.

### BACKGROUND

In the prior art, the distribution network power supply restoration model is typically a mixed-integer optimization problem involving a large number of binary variables, which is primarily solved using centralized computation methods. However, with the increasing number of distributed power sources in the distribution network and the expanding network scale, centralized power supply restoration strategies exhibit many limitations. These limitations include difficulties in unified modeling, high global computational complexity, significant communication pressure, and poor user privacy. Consequently, the power supply restoration method determined for the power grid cluster has low applicability.

So far, no effective solution has been proposed to address the above-mentioned problems.

### SUMMARY OF PRESENT INVENTION

Embodiments of the present disclosure provide a power supply restoration method and apparatus for a power grid cluster, a storage medium, and an electronic device. The present disclosure at least solves the technical problem in the related art that the power supply restoration method determined for the power grid cluster has low applicability.

According to an aspect of the embodiments of the present disclosure, a power supply restoration method for a power grid cluster is provided, including: acquiring a cluster parameter of a target power grid cluster in response to a power supply fault occurred in a target power grid cluster, where the cluster parameter includes at least a node voltage and a node power of each node in the target power grid cluster; constructing a power supply restoration model corresponding to the target power grid cluster based on the cluster parameter, and solving the power supply restoration model to obtain an initial power supply restoration strategy; reconstructing the initial power supply restoration strategy based on an alternating direction method of multipliers to obtain a target power supply restoration strategy; and handling the power supply fault of the target power grid cluster to recover power supply based on the target power supply restoration strategy.

Optionally, the node power includes an active power and a reactive power; and the constructing the power supply restoration model corresponding to the target power grid cluster based on the cluster parameter includes: constructing a distribution network linear power flow model based on the node voltage, the active power, and the reactive power, where the distribution network linear power flow model is configured to balance a voltage and a power on a circuit during a power supply restoration process; and constructing the power supply restoration model based on the distribution network linear power flow model.

Optionally, the power supply restoration model includes an objective equation and a constraint; the objective equation is configured to express a maximum load restoration amount of the target power grid cluster; the constraint is configured to control a voltage magnitude of each node in the target power grid cluster; and the solving the power supply restoration model to obtain the initial power supply restoration strategy includes: solving the objective equation based on the constraint to obtain the initial power supply restoration strategy.

Optionally, the reconstructing the initial power supply restoration strategy based on the alternating direction method of multipliers to obtain a target power supply restoration strategy includes: relaxing the initial power supply restoration strategy based on a relaxation model to obtain a relaxation result; and performing integer process on the relaxation result based on an integer function to obtain the target power supply restoration strategy.

Optionally, the relaxing the initial power supply restoration strategy based on the relaxation model to obtain the relaxation result includes: initializing a common variable and a multiplier of the relaxation model; solving the relaxation model based on the initial power supply strategy to obtain a model solution value; continuously solving, when the model solution value does not meet a first convergence condition, the relaxation model until the model solution value meets the first convergence condition, where the first convergence condition is configured to indicate that when the power supply restoration strategy is solved based on the relaxation model, a first primal residual is less than a first threshold and a first dual residual is less than a second threshold; and determining, when the model solution value meets the first convergence condition, the model solution value as the relaxation result.

Optionally, the performing integer process on the relaxation result based on the integer function to obtain the target power supply restoration strategy includes: processing the relaxation result based on the integer function to obtain an integer result; continuously processing, when the integer result does not meet a second convergence condition, the relaxation result based on the integer function until the integer result meets the second convergence condition, where the second convergence condition is configured to indicate that when the relaxation result is processed based on the integer function, a second primal residual is less than a third threshold and a second dual residual is less than a fourth threshold; and determining, when the integer result meets the second convergence condition, the integer result as the target power supply restoration strategy.

Optionally, the method further includes: performing network decomposition on a boundary node of a power grid cluster with a power supply fault through a node tearing method to obtain a virtual node; and adding the virtual node to the power grid cluster with the power supply fault to obtain the target power grid cluster.

According to another aspect of the embodiments of the present disclosure, a power supply restoration apparatus for a power grid cluster is provided, including: an acquisition module, configured to acquire a cluster parameter of a target power grid cluster in response to a power supply fault occurred in the target power grid cluster, where the cluster parameter includes at least a node voltage and a node power of each node in the target power grid cluster; a first processing module, configured to construct a power supply restoration model corresponding to the target power grid cluster based on the cluster parameter, and solve the power supply restoration model to obtain to obtain an initial power supply restoration strategy; a second processing module, configured to reconstruct the initial power supply restoration strategy based on an alternating direction method of multipliers to obtain a target power supply restoration strategy; and a restoration module, configured to handle the power supply fault of the target power grid cluster to recover power supply based on the target power supply restoration strategy.

According to another aspect of the embodiments of the present disclosure, a non-transitory computer-readable storage medium is provided, including a stored program, and when the program is run, a processor in a device where the program is located implements any of the method described above.

According to another aspect of the embodiments of the present disclosure, an electronic device is provided, including: at least one processor; and a storage apparatus, configured to store at least one program; where, when the at least one program is executed by the at least one processor, the at least one processor implements any of the method described above.

In the power supply restoration method for a power grid cluster according to the embodiment of the present disclosure, when a power supply fault occurs in a target power grid cluster, a cluster parameter of the target power grid cluster is acquired. The cluster parameter includes at least a node voltage and a node power of each node in the target power grid cluster. A power supply restoration model corresponding to the target power grid cluster is constructed based on the cluster parameter, and the power supply restoration model is solved to acquire an initial power supply restoration strategy. The initial power supply restoration strategy is reconstructed based on an alternating direction method of multipliers, and a target power supply restoration strategy is acquired. The power supply fault of the target power grid cluster is handled based on the target power supply restoration strategy. It is easy to notice that the power supply restoration model corresponding to the target power grid cluster can be constructed based on the cluster parameter, and the initial power supply restoration strategy can be acquired by solving the power supply restoration model. Furthermore, the initial power supply restoration strategy can be reconstructed based on the alternating direction method of multipliers to determine the corresponding target power supply restoration strategy. Since the alternating direction method of multipliers can relax binary variables into real variables, the complexity of the power supply restoration model can be greatly reduced. Besides, the non-convex model can be transformed into a convex model through relaxation, thereby greatly improving the applicability of the power supply restoration method. The design solves the technical problem in the related art that the power supply restoration method determined for the power grid cluster has low applicability.

### BRIEF DESCRIPTION OF THE DRAWINGS

The drawings described here are provided for further understanding of the present disclosure, and constitute a part of the application. The exemplary embodiments and illustrations thereof of the present disclosure are intended to explain the present disclosure, but do not constitute inappropriate limitations to the present disclosure. Figures:

FIG. 1 is a flowchart of a power supply restoration method for a power grid cluster according to an embodiment of the present disclosure;

FIG. 2 is a schematic diagram of the power supply restoration method for a power grid cluster according to an embodiment of the present disclosure; and

FIG. 3 is a schematic diagram of a power supply restoration apparatus for a power grid cluster according to an embodiment of the present disclosure.

### DETAILED DESCRIPTION OF THE EMBODIMENTS

To make persons skilled in the art better understand the present disclosure, the following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by persons of ordinary skill in the art based on the embodiments of the present disclosure without creative efforts shall fall within the scope of protection of the present disclosure.

It should be noted that terms such as “first” and “second” in the specification, the claims and the drawings of the present disclosure are intended to distinguish between similar objects but do not necessarily indicate a specific order or sequence. It should be understood that the data used in such a way may be exchanged under proper conditions to make it possible to implement the described embodiments of the present disclosure in other sequences apart from those illustrated or described herein. In addition, the terms “including” and “having”, and any variations thereof, are intended to cover non-exclusive inclusion, for example, a process, method, system, product, or device including a series of steps or units is not necessarily limited to those steps or units explicitly listed, but may include other steps or units not explicitly listed or inherent to these processes, methods, products, or devices.

### Embodiment 1

According to the embodiments of the present disclosure, an embodiment of a power supply restoration method for a power grid cluster is provided. It should be noted that, steps shown in the flowchart in the drawings may be executed in a computer system such as a set of computer-executable instructions. Moreover, although a logic sequence is shown in the flowchart, the shown or described steps may be executed in a sequence different from that described here.

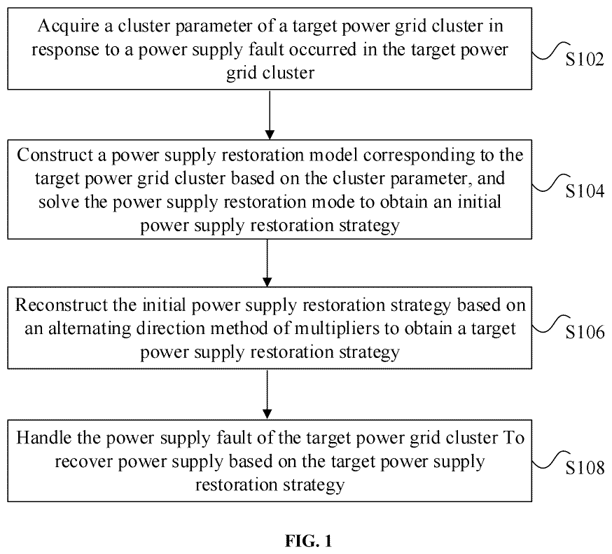

FIG. 1 is a flowchart of a power supply restoration method for a power grid cluster according to an embodiment of the present disclosure. As shown in FIG. 1, the method includes following steps.

In step S102, a cluster parameter of a target power grid cluster is acquired in response to a power supply fault occurred in the target power grid cluster. The cluster parameter includes at least a node voltage and a node power of each node in the target power grid cluster.

The target power grid cluster may be a power grid cluster where a power supply fault occurs. Optionally, the target power grid cluster may include a plurality of power supply nodes.

In an optional embodiment, after a power supply fault occurs in the target power grid cluster, the cluster parameter of the target power grid cluster is acquired. Optionally, the cluster parameter may be acquired through the following method.

A management department or an operator of the power grid cluster is contacted to apply for permission to acquire the cluster parameter and relevant data.

If there is a legal permission available, a management system or related platform of the power grid cluster can be logged in to view and download information related to the cluster parameter.

A relevant power grid cluster standard and specification may be referred to understand the definition and acquisition method of the cluster parameter.

If more detailed information is needed, a technical person or expert of the power grid cluster may be communicated with to acquire assistance and guidance.

In step S104, a power supply restoration model corresponding to the target power grid cluster is constructed based on the cluster parameter, and the power supply restoration model is solved to obtain an initial power supply restoration strategy.

The power supply restoration model may be a mathematical model configured to output the initial power supply restoration strategy.

In an optional embodiment, after the cluster parameter is acquired, the cluster parameter is utilized to construct the corresponding power supply restoration model, thereby enabling the power supply restoration model to output the corresponding initial power supply restoration strategy. Optionally, when the corresponding power supply restoration model is constructed, a distribution network linear power flow model is first constructed based on the cluster parameter, and the corresponding power supply restoration model is constructed through the distribution network linear power flow model. Optionally, the cluster parameter may be directly utilized to construct the power supply restoration model.

In step S106, the initial power supply restoration strategy is reconstructed based on an alternating direction method of multipliers to obtain a target power supply restoration strategy.

In an optional embodiment, the initial power supply restoration strategy is reconstructed through the alternating direction method of multipliers to obtain the target power supply restoration strategy. Optionally, the target power supply restoration strategy may be configured for power supply restoration. The alternating direction method of multipliers is an optimization algorithm configured to solve nonlinear programming problems. It combines the ideas of the method of multipliers and the alternating direction method, and iteratively updates variables and multipliers to gradually optimize the function.

The initial power supply restoration strategy may be reconstructed based on the alternating direction method of multipliers according to following steps.
(1) Lagrange multipliers are introduced. Lagrange multipliers are introduced to handle a constraint, transforming the constraint into a constraint within an objective function.
(2) The alternating direction method of multipliers is applied. The alternating direction method of multipliers is applied to iteratively solve for a power supply restoration strategy, i.e., by alternately updating a primal variable and the Lagrange multipliers to gradually optimize the corresponding function.
(3) The target power supply restoration strategy is acquired. The finally acquired power supply restoration strategy is the target power supply restoration strategy reconstructed based on the alternating direction method of multipliers, and an optimal solution may be acquired through numerical calculation or an optimization algorithm.

In step S108, the power supply fault of the target power grid cluster is handled to recover power supply based on the target power supply restoration strategy.

In an optional embodiment, the power supply fault of the target power grid cluster is handled based on the target power supply restoration strategy according to following steps.

First, a power supply restoration objective of the target power grid cluster is determined, including restoration time, restoration scope, restoration quality, etc.

Second, a cause of the power supply fault is analyzed, including fault type, fault scope, fault impact, etc., to formulate a corresponding restoration strategy.

Third, the power supply restoration strategy is formulated, i.e., based on a fault analysis result, the corresponding power supply restoration strategy is formulated, including restoration plan, restoration resource, restoration time, etc.

Fourth, the power supply restoration plan is implemented, i.e., based on the formulated power supply restoration strategy, the power supply restoration plan is organized and implemented, including dispatching personnel, dispatching equipment, and the dispatching process, etc.

Furthermore, the power supply restoration process is monitored. During the power supply restoration process, the power supply situation is monitored in a timely manner to ensure the restoration process proceeds smoothly.

Finally, a power supply restoration record is made. Optionally, after the restoration process is completed, the power supply restoration process is recorded and summarized for subsequent fault analysis and improvement.

In the power supply restoration method for a power grid cluster according to the embodiment of the present disclosure, when a power supply fault occurs in a target power grid cluster, a cluster parameter of the target power grid cluster is acquired. The cluster parameter includes at least a node voltage and a node power of each node in the target power grid cluster. A power supply restoration model corresponding to the target power grid cluster is constructed based on the cluster parameter, and the power supply restoration model is solved to acquire an initial power supply restoration strategy. The initial power supply restoration strategy is reconstructed based on an alternating direction method of multipliers, and a target power supply restoration strategy is acquired. The power supply fault of the target power grid cluster is handled based on the target power supply restoration strategy. It is easy to notice that the power supply restoration model corresponding to the target power grid cluster can be constructed based on the cluster parameter, and the initial power supply restoration strategy can be acquired by solving the power supply restoration model. Furthermore, the initial power supply restoration strategy can be reconstructed based on the alternating direction method of multipliers to determine the corresponding target power supply restoration strategy. Since the alternating direction method of multipliers can relax binary variables into real variables, the complexity of the power supply restoration model can be greatly reduced. Besides, the non-convex model can be transformed into a convex model through relaxation, thereby greatly improving the applicability of the power supply restoration method. The design solves the technical problem in the related art that the power supply restoration method determined for the power grid cluster has low applicability.

Optionally, the node power includes an active power and a reactive power. When the power supply restoration model corresponding to the target power grid cluster is constructed based on the cluster parameter, the distribution network linear power flow model is constructed based on the node voltage, active power, and reactive power. The distribution network linear power flow model is configured to balance a voltage and a power on a circuit during a power supply restoration process. The power supply restoration model is constructed based on the distribution network linear power flow model.

In an optional embodiment, to accelerate the solving speed of the power supply restoration model, a new type of distribution network linear power flow model may be first constructed. The impact of neglecting branch impedance in the distribution network linear power flow model is smaller compared to that of a general linear power flow model. The branch power flow between two nodes in the general linear power flow model is:

$$\{ \begin{matrix}{P}_{ij} \approx - {P}_{ji} \\ {Q}_{ij} \approx - {Q}_{ji}\end{matrix}$$

where, Pᵢⱼ denotes an active power transmitted from a node i to a node j; Pⱼᵢ denotes an active power transmitted from the node j to the node i; Qᵢⱼ denotes a reactive power transmitted from the node i to the node j; and Qⱼᵢ denotes a reactive power transmitted from the node j to the node i.

In the present disclosure, a branch power flow constraint between two nodes in the linear power flow model is:

$$\{ \begin{matrix}\frac{{P}_{ij}}{{U}_{i}} \approx - \frac{{P}_{ji}}{{U}_{j}} \\ \frac{{Q}_{ij}}{{U}_{i}} \approx - \frac{{Q}_{ji}}{{U}_{j}}\end{matrix} \qquad ( 1 )$$

where, Uᵢ denotes a node voltage of a front-end node i of a branch ij; and Uⱼ denotes a node voltage of a back-end node j of the branch ij. In this equation, the front-end and back-end currents of the branch ij are approximately equal. Auxiliary variables P_{ij,b}, Q_{ij,b}, P_{i,b}, and Q_{i,b} are introduced in the model, representing ratios of the branch power and the node power injection to the voltage, respectively:

$$\{ \begin{matrix}{P}_{ij , b} = \frac{{P}_{ij}}{{U}_{i}} , {P}_{i , b} = \frac{{P}_{i}}{{U}_{i}} \\ {Q}_{ij , b} = \frac{{Q}_{ij}}{{U}_{i}} , {Q}_{i , b} = \frac{{Q}_{i}}{{U}_{i}}\end{matrix} \qquad ( 2 )$$

where, P_{ij,b} denotes a ratio of the branch active power Pᵢⱼ to the voltage Uᵢ of the node i; P_{i,b} denotes a ratio of the active power injection Pᵢ at the node i to the voltage Uᵢ of the node i; Q_{ij,b} denotes a ratio of the branch reactive power Qᵢⱼ to the voltage Uᵢ of the node i; and Q_{i,b} denotes a ratio of the reactive power injection Qᵢ at the node i to the voltage of the node Uᵢ.

Through the equality relationship between the active power, the reactive power, and the node voltage in the branch power flow equation, a voltage balance equation between the two nodes is derived by neglecting a vertical component of the voltage:

$${U}_{i} - {U}_{j} = {R}_{ij} \frac{{P}_{ij}}{{U}_{i}} + {X}_{ij} \frac{{Q}_{ij}}{{U}_{i}} \qquad ( 3 )$$

where, Rᵢⱼ and Xᵢⱼ denote a resistance and a reactance of the branch ij, respectively.

Furthermore, substituting Eq. (2) into Eq. (3) yields:

$${U}_{i} - {U}_{j} = {R}_{ij} {P}_{ij , b} + {X}_{ij} {Q}_{ij , b} \qquad ( 4 )$$

Since the operation of dividing two variables is often difficult to solve in the mathematical model, an auxiliary variable Wᵢ is introduced to describe a reciprocal of the voltage Uᵢ, thereby linearizing the model:

$${W}_{i} = \frac{1}{{U}_{i}} \qquad ( 5 )$$

By performing a first-order Taylor expansion of

$$\frac{1}{{U}_{i}}$$

at Uᵢ=1, a linear approximation expression of Wᵢ is acquired:

$${W}_{i} = 2 - {U}_{i} \qquad ( 6 )$$

Finally, the constructed distribution network linear power flow model is:

$$\{ \begin{matrix}{P}_{hi , b} + {P}_{i , b} + {\sum }_{j ∈ {N}_{c} ( i )} {P}_{ij , b} \\ {Q}_{hi , b} + {Q}_{i , b} + {\sum }_{j ∈ {N}_{c} ( i )} {Q}_{ij , b} \\ {P}_{i , b} = - {W}_{i} {p}_{j} + {P}_{Gi} {W}_{0} \\ {Q}_{i , b} = - {W}_{i} {q}_{j} + {Q}_{Gi} {W}_{0}\end{matrix} \qquad ( 7 )$$

where, h denotes an upstream node of the node i; N_{c}(i) denotes a set of all downstream nodes of the node i; W₀ is a constant, which takes a value that is the reciprocal of the value of a balanced node in the distribution network; pⱼ and qⱼ denote a net active power consumption and a net reactive power consumption of a load node, respectively; and P_{Gi} and Q_{Gi} denote an active power and a reactive power of a distributed power source at the node i, respectively. Optionally, after the distribution network linear power flow model is acquired, the corresponding power supply restoration model is constructed based on the distribution network linear power flow model.

Optionally, the power supply restoration model includes an objective equation and a constraint. The objective equation is configured to express a maximum load restoration amount of the target power grid cluster. The constraint is configured to control a voltage magnitude of each node in the target power grid cluster. The power supply restoration model is solved to acquire the initial power supply restoration strategy. Specifically, based on the constraint, the objective equation is solved to acquire the initial power supply restoration strategy.

The objective equation may be used for the maximum load restoration amount in the fault power supply restoration reconfiguration problem.

In an optional embodiment, to keep the topology of the distribution network reconfiguration as normal as possible, different weight coefficients are applied to the switch states of each branch in the objective function (8):

$$max {c}_{1} {\sum }_{i = {N}_{L}} ( {w}_{i}^{L} {P}_{i} ) + {c}_{2} {\sum }_{{ij ∈ ε}^{}} ( {w}_{ij}^{S} {α}_{ij} ) \qquad ( 8 )$$

where, N_{L} denotes a set of all load nodes in the system; [symbol] denotes a set of all lines in the system; Pᵢ denotes a load restoration amount of the node i;

$${w}_{i}^{L}$$

denotes a priority weight coefficient of the load; αᵢⱼ denotes a branch switch state; αᵢⱼ=0 indicates a branch switch is open; αᵢⱼ=1 indicates the branch switch is closed; and

$${w}_{ij}^{S}$$

denotes a priority weight coefficient of the branch switch. To reduce the switching operation cost, normally closed sectionalizing switches often have a larger priority weight coefficient than normally open tie switches, and c₁ and c₂ are the normalization coefficients of the above two terms.

Furthermore, the following security operation constraint can be applied to the objective function.

Security operation constraint: In this cluster, the node voltage magnitude does not exceed a limit, the branch transmission power does not exceed a security limit, and the photovoltaic output power does not exceed a capacity constraint, etc.

$$\{ \begin{matrix}{x}_{Li} {U}_{min} \leq {U}_{i} \leq {x}_{Li} {U}_{max} \\ {W}_{i} = 2 - {U}_{i}\end{matrix} \qquad ( 9 )$$

$$\{ \begin{matrix}{P}_{ij , b}^{2} + {Q}_{ij , b}^{2} \leq {\overline{I}}_{ij}^{2} \\ - {α}_{ij} M \leq {P}_{ij , b} \leq {α}_{ij} M \\ - {α}_{ij} M \leq {Q}_{ij , b} \leq {α}_{ij} M\end{matrix} \qquad ( 10 )$$

$$\{ \begin{matrix}{P}_{i}^{L} = {x}_{Li} {p}_{i} \\ {Q}_{i}^{L} = {x}_{Li} {q}_{i}\end{matrix} \qquad ( 11 )$$

$${P}_{Gi}^{2} + {Q}_{Gi}^{2} \leq {S}_{Gi}^{2} \qquad ( 12 )$$

where, x_{Li} denotes a power-on state of the load node; x_{Li}=0 indicates the load node is not powered; x_{Li}=1 indicates the load node is powered; Īᵢⱼ denotes a maximum safe current flowing through the branch ij; and M is a large constant. Different from Eq. (2), Pᵢ^{L} and Qᵢ^{L} here are redefined as a load and a reactive power restored for the node i, respectively; pᵢ and qᵢ denote a net active power consumption and a net reactive power consumption of the load node i, respectively; and P_{Gi}, Q_{Gi}, and S_{Gi} denote an active power, a reactive power, and an installed capacity of the distributed power source in the distribution network at the load node i, respectively.

### Linear Power Flow Balance Constraint:

$$\{ \begin{matrix}{P}_{hi , b} + {P}_{i , b} = {\sum }_{j ∈ {N}_{c} ( i )} {P}_{ij , b} \\ {Q}_{hi , b} + {Q}_{i , b} = {\sum }_{j ∈ {N}_{c} ( i )} {Q}_{ij , b} \\ - M ( 1 - {x}_{Li} ) + ( - {W}_{i} {p}_{j} + {P}_{Gi} {W}_{0} ) \leq {P}_{i , b} \leq \\ M ( 1 - {x}_{Li} ) + ( - {W}_{i} {p}_{j} + {P}_{Gi} {W}_{0} ) \\ - M ( 1 - {x}_{Li} ) + ( - {W}_{i} {q}_{j} + {Q}_{Gi} {W}_{0} ) \leq {Q}_{i , b} \leq \\ M ( 1 - {x}_{Li} ) + ( - {W}_{i} {q}_{j} + {Q}_{Gi} {W}_{0} )\end{matrix} \qquad ( 13 )$$

$$- M ( 1 - {α}_{ij} ) {W}_{i} - ( {R}_{ij} {P}_{ij , b} + {X}_{ij} {Q}_{ij , b} ) \leq {W}_{j} \leq M ( 1 - {α}_{ij} ) + {W}_{i} + ( {R}_{ij} {P}_{ij , b} + {X}_{ij} {Q}_{ij , b} ) \qquad ( 14 )$$

where, h denotes an upstream node of the node i; W₀ is a constant, which takes a value that is the reciprocal of the value of a balanced node in the distribution network. Multiplying the load power supply state x_{Li} directly by the active power injection (−Wᵢpⱼ+P_{Gi}W₀) and the reactive power injection (−Wᵢqⱼ+Q_{Gi}W₀) results in the multiplication of two variables, making the solution difficult. Therefore, the model uses a big-M method to relax the power flow balance equation of the power injection part. Eq. (14) also uses the big-M method to relax the voltage balance equation.

Radial topology constraint: The present disclosure uses a spanning tree constraint method to ensure the topology is radial.

$${β}_{ij} + {β}_{ji} = {α}_{ij} \qquad ( 15 )$$

$$\{ \begin{matrix}{\sum }_{j ∈ {N}_{L}} {β}_{ij} = 1 \\ {β}_{0 j} = 0\end{matrix} \qquad ( 16 )$$

where, βᵢⱼ and βⱼᵢ denote binary variables of an upstream-downstream relationship between nodes; and βᵢⱼ=1 indicates that j is a parent node of i; βⱼᵢ=1 indicates that i is a parent node of j. Eq. (15) indicates that for the branch ij, if the switch is closed, j must be the parent node of i or i must be the parent node of j. If αᵢⱼ=0, then βᵢⱼ=βⱼᵢ=0. Eq. (16) indicates that except for a source node, each node has exactly one parent node, and the source node has no parent node.

The constructed power supply restoration model can be written in the following compact form:

$$min {f}_{i} ( {x}_{i} , {z}_{i} ) \qquad ( 17 )$$

$$s . t . {x}_{i} ∈ X$$

$${z}_{i} ∈ Z$$

where, fᵢ(xᵢ,zᵢ) denotes an objective function of a cluster i; xᵢ and zᵢ denote a continuous variable and a binary variable of the model in the cluster i, respectively; xᵢ=[P_{ij,b},Q_{ij,b},P_{i,b},Q_{i,b},Uᵢ], zᵢ=[x_{Li},αᵢⱼ,βᵢⱼ]; set X denotes a feasible region of the continuous variable xᵢ; and set Z denotes a feasible region of the binary variable zᵢ.

Optionally, the initial power supply restoration strategy is reconstructed based on the alternating direction method of multipliers to obtain the target power supply restoration strategy. Specifically, the initial power supply restoration strategy is relaxed based on a relaxation model to acquire a relaxation result. Integer process in performed on the relaxation result based on an integer function to acquire the target power supply restoration strategy.

The relaxation model may be a mathematical optimization model configured to solve problems with many or complex constraints. In the relaxation model, the original constraint is relaxed or transformed into part of the objective function to make the problem easier to solve. This method reduces the complexity of the problem, making originally difficult problem easier to handle.

The integer function refers to a function with an integer data type return value. This function can perform various integer operations, logical operations, or return integer-type results. For example, functions that calculate the sum, difference, product, or quotient of two integers all belong to integer functions. Additionally, integer functions can also be configured to determine whether an integer is a prime, calculate factorials, and calculate Fibonacci sequences, etc. Integer functions are frequently used in programming because integer operations are one of the most basic operations in computers.

In an optional embodiment, after the power supply restoration model is acquired, the initial power supply restoration strategy is relaxed based on the relaxation model to acquire a relaxation result. Integer process is performed on the relaxation result based on the integer function to acquire the target power supply restoration strategy.

Optionally, the power supply restoration strategy is relaxed based on the relaxation model to acquire the relaxation result. Specifically, common variables and multipliers of the relaxation model are initialized. The relaxation model is solved based on the initial power supply strategy to acquire a model solution value. When the model solution value does not meet a first convergence condition, the relaxation model is continuously solved until the model solution value meets the first convergence condition. The first convergence condition is configured to indicate that when the power supply restoration strategy is solved based on the relaxation model, a first primal residual is less than a first threshold and a first dual residual is less than a second threshold. When the model solution value meets the first convergence condition, the model solution value is determined as the relaxation result.

In an optional embodiment, when the power supply restoration strategy is relaxed based on the relaxation model, the common variables and multipliers of the relaxation model may be first initialized. The specific relaxation process is as follows:
In Eq. (17), the continuous variable xᵢ includes a boundary variable

$${x}_{i}^{b}$$

and an internal variable

$${x}_{i}^{n} ,$$

i.e.,

$${x}_{i} = [ {x}_{i}^{b} , {x}_{i}^{n} ] ;$$

the binary variable zᵢ includes a switch state variable and a load restoration state variable

$${z}_{i} = [ {z}_{i}^{S} , {z}_{i}^{L} ] .$$

Optionally, an auxiliary variable y is introduced to denote a value after linear relaxation of the binary variable, yᵢ=zᵢ, 0≤yᵢ≤1, and a variable xᵢ∈R is introduced to denote the common variable of the boundary variable

$${x}_{i}^{b} .$$

Optionally, each smart cluster agent performs the following iterative update process:

First, initial values are assigned to continuous common variables and all binary common variables based on historical data, and initial values are randomly assigned to a Lagrange multiplier u_{1,i} of a continuous boundary variable equality constraint

$${x}_{i}^{b} - {\overline{x}}_{i} = 0$$

and a Lagrange multiplier u_{2,i} of a binary variable equality constraint yᵢ−zᵢ=0. Eq. (18) is configured to solve for xᵢ and yᵢ of this cluster.

$${( {x}_{i} , {y}_{i} )}^{( k + 1 )} = argmin [ {f}_{i} ( {x}_{i} , {y}_{i} ) + \frac{ρ}{2} {\vert {x}_{i}^{b} - {\overline{x}}_{i}^{( k )} + {u}_{1 , i}^{( k )} \vert}^{2} + \frac{ρ}{2} {\vert {y}_{i} - {z}_{i}^{( k )} + {u}_{2 , i}^{( k )} \vert}^{2} ] \qquad ( 18 )$$

where, [symbol] denotes a penalty coefficient during an iteration process; and k denotes an iteration count.

Then, the common variables and Lagrange multipliers between adjacent clusters are updated based on the continuous boundary variable

$${x}_{i}^{b}$$

and the relaxed auxiliary variable yᵢ acquired from Eq. (18) for the next iteration. The continuous common variables and binary common variables between adjacent clusters are updated according to Eq. (19). In Eq. (19), all binary variables zᵢ previously replaced by yᵢ are redefined as the updated binary common variables.

$$\{ \begin{matrix}{\overline{x}}_{i}^{( k + 1 )} = \frac{1}{{B}_{xi}} {\sum }_{i = 1}^{{B}_{xi}} ( {x}_{i}^{b ( k + 1 )} + {u}_{1 , i}^{( k )} ) \\ {z}_{i}^{( k + 1 )} = prox ( \frac{1}{{B}_{zi}} {\sum }_{i = 1}^{{B}_{zi}} ( {y}_{i}^{( k + 1 )} + {u}_{2 , i}^{( k )} ) )\end{matrix} \qquad ( 19 )$$

$$\{ \begin{matrix}{u}_{1 , i}^{( k + 1 )} = {u}_{1 , i}^{( k )} + {x}_{i}^{b ( k + 1 )} - {\overline{x}}_{i}^{( k )} \\ {u}_{2 , i}^{( k + 1 )} = {u}_{2 , i}^{( k )} + {y}_{i}^{( k + 1 )} - {z}_{i}^{( k + 1 )}\end{matrix} \qquad ( 20 )$$

where, Bₓᵢ and B_{zi} are constants, representing eigenvalues of the updated variables x̅ᵢ̅ and zᵢ as boundary variables or internal variables; if the updated variable is a boundary variable, its value is 2; if the updated variable is an internal variable of the cluster, its value is 1; and prox denotes a proximal operator, expressed as:

$$prox ( w ) = {( 1 + {s}^{( k )} )}^{- 1} ( w + {s}^{( k )} {\prod }_{S} ( w ) ) \qquad ( 21 )$$

where, s denotes an integer parameter; and Πₛ denotes a projection (rounding). In the relaxation phase, to keep the integer parameter as s=0, zᵢ is relaxed to zᵢ=w. At this time, the power supply restoration model is a linear model without complex binary variables and is easy to solve.

After the common variables and Lagrange multipliers are updated through Eqs. (19) and (20), they are substituted into Eq. (18) for the next iteration. The above iteration process is repeated until the primal residual and dual residual are sufficiently small to meet the boundary convergence condition. That is, when the model solution value does not meet the first convergence condition, the relaxation model is continuously solved until the model solution value meets the first convergence condition. The primal residual and dual residual are as follows:

$$\{ \begin{matrix}{r}_{p}^{( k )} = {\sum }_{i = 1}^{C} \vert {y}_{i}^{( k )} - {z}_{i}^{( k )} \vert + \vert {x}_{i}^{b ( k )} - {\overline{x}}_{i}^{( k )} \vert \\ {r}_{d}^{( k )} = {\sum }_{i = 1}^{C} ρ \vert {z}_{i}^{( k )} - {z}_{i}^{( k - 1 )} \vert + ρ \vert {\overline{x}}_{i}^{( k )} - {\overline{x}}_{i}^{( k - 1 )} \vert\end{matrix} \qquad ( 22 )$$

where, C denotes a number of clusters in the entire distribution network; rₚ denotes the primal residual during the iteration, represented by a difference between each cluster's boundary continuous variable and a consensus continuous variable, and a difference between the internal and boundary binary variables of each cluster and the consensus binary variable; and r_{d} denotes the dual residual, calculated as a difference between the continuous common variable and the binary common variable at a k-th iteration and their values at a (k−1)-th iteration.

Optionally, integer process is performed on the relaxation result based on the integer function to acquire the target power supply restoration strategy. Specifically, the relaxation result is processed based on the integer function to acquire an integer result. When the integer result does not meet a second convergence condition, the relaxation result is continuously processed based on the integer function until the integer result meets the second convergence condition. The second convergence condition is configured to indicate that when the relaxation result is processed based on the integer function, a second primal residual is less than a third threshold and a second dual residual is less than a fourth threshold. When the integer result meets the second convergence condition, the integer result is determined as the target power supply restoration strategy.

In an optional embodiment, the integer process is as follows.

This phase uses the result of the relaxation phase, i.e., the relaxation result, as the initial value, and iterates through Eqs. (20) to (24), but the integer parameter s needs to be updated.

In the integer phase, the result acquired from the relaxation phase is used as the initial value at k−1. Eq. (20) is configured to solve for xᵢ and yᵢ of each cluster. xᵢ and yᵢ are substituted into Eqs. (18) to (22) to update the common variables and Lagrange multipliers. The primal residual and dual residual of this iteration are calculated through Eq. (22). That is, when the integer result does not meet the second convergence condition, the relaxation result is continuously processed based on the integer function until the integer result meets the second convergence condition. Finally, in the integer phase, the integer parameter s is updated based on the primal residual and dual residual.

During the iteration, s is updated as follows:

$${s}^{( k )} = {s}^{( k - 1 )} + c ( 1 / {r}_{p}^{( k - 1 )} + 1 / {r}_{d}^{( k - 1 )} ) \qquad ( 23 )$$

where, c is a small constant. Optionally, the updated s is substituted into Eq. (19) in the next iteration. As the iteration process proceeds, the binary common variable zᵢ is updated to a Boolean value of 0 or 1 through Eq. (19).

Optionally, the method further includes following steps. Network decomposition is performed on a boundary node of a power grid cluster with a power supply fault through a node tearing method to acquire a virtual node. The virtual node is added to the power grid cluster with a power supply fault to acquire the target power grid cluster.

The basic principle of the node tearing method is to copy the boundary node between this cluster and an adjacent cluster into this cluster as a virtual node of this cluster. There are equality constraints on the boundary node voltage, and active power and reactive power transmitted through the boundary branch between the virtual node and the original boundary node of the adjacent cluster. Therefore, network decomposition can be performed on the boundary node of the power grid cluster with a power supply fault to acquire the virtual node, and the virtual node is added to the power grid cluster with a power supply fault to acquire the target power grid cluster.

Specifically, the above process is expressed as follows:

$$\{ \begin{matrix}{U}_{i} = {U}_{{i}^{′}} \\ {P}_{{ij}^{′}} = {P}_{{i}^{′} j} \\ {Q}_{{ij}^{′}} = {Q}_{{i}^{′} j}\end{matrix} \qquad ( 24 )$$

where, Uᵢ denotes a voltage of an original boundary node of the adjacent cluster; U_{i′} denotes a voltage of the virtual node copied into this cluster; P_{ij′} and Q_{ij′} denote active and reactive power of a branch between a boundary node i of this cluster and a virtual node j′ copied from the adjacent cluster; P_{i′j} and Q_{i′j} denote active and reactive power of a branch between a virtual node i′ copied into the adjacent cluster from this cluster and a boundary node j of the adjacent cluster.

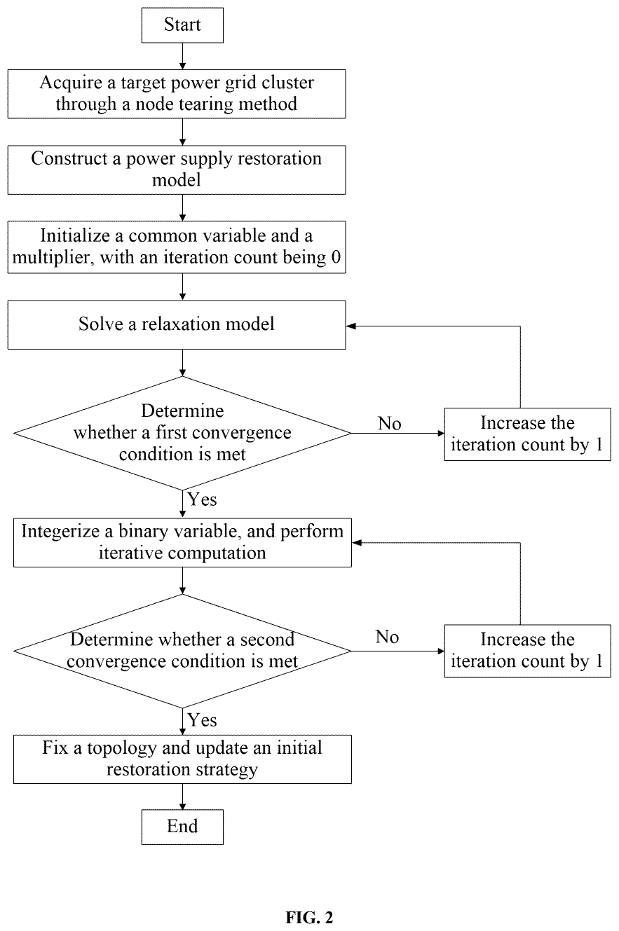

FIG. 2 is a schematic diagram of the power supply restoration method for a power grid cluster according to an embodiment of the present disclosure. As shown in FIG. 2, after the power supply restoration is started, network decomposition is first performed on the boundary node of the power grid cluster with a power supply fault through the node tearing method to acquire the virtual node. The virtual node is added to the power grid cluster with a power supply fault to acquire the target power grid cluster. Furthermore, the power supply restoration model is constructed. After the power supply restoration model is constructed, the common variables and multipliers are initialized, and the iteration count is set to 0. Furthermore, the relaxation model is solved based on the initial power supply strategy acquired from solving the power supply restoration model. Optionally, during the solving process, it is determined whether the acquired model solution value meets the first convergence condition. If the model solution value meets the first convergence condition, it is determined as the relaxation result, and iterative computation for performing integer process on the binary variable is performed on the relaxation result. If the model solution value does not meet the first convergence condition, the iteration count is increased by 1, and the relaxation model is continuously solved. Optionally, during the iterative computation for performing integer process on the binary variable, it is determined whether the acquired integer result meets the second convergence condition. If the integer result meets the second convergence condition, a topology is fixed, and the initial restoration strategy is updated. That is, the integer result is determined as the target restoration strategy. If the acquired integer result does not meet the second convergence condition, the iteration count is increased by 1, and integer is continued.

### Embodiment 2

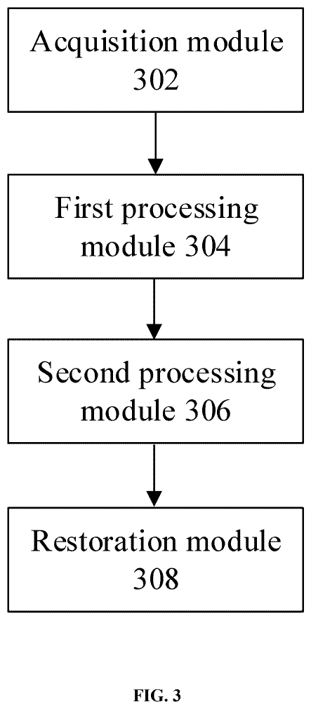

An embodiment of the present disclosure provides a power supply restoration apparatus for a power grid cluster. FIG. 3 is a schematic diagram of the power supply restoration apparatus for a power grid cluster according to an embodiment of the present disclosure. As shown in FIG. 3, the modules of the apparatus are described below.

An acquisition module 302 is configured to acquire, when a power supply fault occurs in a target power grid cluster, a cluster parameter of the target power grid cluster, where the cluster parameter includes at least a node voltage and a node power of each node in the target power grid cluster.

A first processing module 304 is configured to construct a power supply restoration model corresponding to the target power grid cluster based on the cluster parameter, solve the power supply restoration model to obtain an initial power supply restoration strategy.

A second processing module 306 is configured to reconstruct the initial power supply restoration strategy based on an alternating direction method of multipliers to obtain a target power supply restoration strategy.

A restoration module 308 is configured to handle the power supply fault of the target power grid cluster based on the target power supply restoration strategy.

Optionally, the first processing module 304 includes: a first construction unit, configured to construct a distribution network linear power flow model based on the node voltage, an active power, and a reactive power, where the distribution network linear power flow model is configured to balance a voltage and a power on a circuit during a power supply restoration process; and a second construction unit, configured to construct the power supply restoration model based on the distribution network linear power flow model.

Optionally, the first processing module 304 further includes a solving unit, configured to solve the objective equation based on a constraint to acquire the initial power supply restoration strategy.

Optionally, the second processing module 306 includes: a first processing unit, configured to relax the initial power supply restoration strategy based on a relaxation model to acquire a relaxation result; and a second processing unit, configured to perform integer process on the relaxation result based on an integer function to acquire the target power supply restoration strategy.

Optionally, the first processing unit includes: an initialization subunit, configured to initialize a common variable and multipliers of the relaxation model; a first solving subunit, configured to solve the relaxation model based on the initial power supply strategy to acquire a model solution value; a second solving subunit, configured to, when the model solution value does not meet a first convergence condition, continuously solve the relaxation model until the model solution value meets the first convergence condition, where the first convergence condition is configured to indicate that when the power supply restoration strategy is solved based on the relaxation model, a first primal residual is less than a first threshold and a first dual residual is less than a second threshold; and a first determination subunit, configured to, when the model solution value meets the first convergence condition, determine the model solution value as the relaxation result.

Optionally, the second processing unit includes: a first processing subunit, configured to process the relaxation result based on the integer function to acquire an integer result; a second processing subunit, configured to, when the integer result does not meet a second convergence condition, continuously process the relaxation result based on the integer function until the integer result meets the second convergence condition, where the second convergence condition is configured to indicate that when the relaxation result is processed based on the integer function, a second primal residual is less than a third threshold and a second dual residual is less than a fourth threshold; and a second determination subunit, configured to, when the integer result meets the second convergence condition, determine the integer result as the target power supply restoration strategy.

Optionally, the apparatus further includes: a decomposition module, configured to perform network decomposition on a boundary node of the power grid cluster with a power supply fault based on a node tearing method to acquire a virtual node; and an addition module, configured to add the virtual node to the power grid cluster with a power supply fault to acquire the target power grid cluster.

### Embodiment 3

Embodiments of the present disclosure further provide a computer-readable storage medium. The computer-readable storage medium includes a stored computer program, and when being run, the program controls a device where the computer-readable storage medium is located to implement the method in any one of the foregoing embodiments.

### Embodiment 4

Embodiments of the present disclosure further provide an electronic device, including one or more processors; and a storage apparatus storing one or more programs, where when the one or more programs are executed by the one or more processors, the one or more processors are caused to implement the method in the foregoing embodiments.

The serial numbers of the embodiments of the present disclosure are merely for description and do not represent a preference of the embodiments.

In the above examples of the present disclosure, the description of the examples each has a focus, and portions not described in detail in one example may refer to the description of other examples.

In several embodiments provided in this application, it should be understood that the disclosed technical content may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In other respects, the inter-coupling or direct coupling or communication connection shown or discussed may be indirect coupling or communication connection through some interfaces, apparatuses, or units, or may be implemented in an electrical form or other forms.

The units described as separate parts may or may not be physically separate. Parts displayed as units may or may not be physical units, which may be located in one position, or may be distributed on a plurality of network units. Some or all of the units may be selected according to actual needs to achieve the objectives of the solutions of embodiments.

In addition, functional units in the embodiments of the present disclosure may be integrated into one processing unit, or each of the units may exist alone physically, or two or more units may be integrated into one unit. The above integrated unit may be implemented either in a form of hardware or in a form of a software functional unit.

The integrated unit, if implemented in the form of a software functional unit and sold or used as a stand-alone product, may be stored in a computer-readable storage medium. Based on such understanding, the technical solution of the present disclosure which is essentially or a part contributing to the prior art or a part of the technical solution may be embodied in the form of a software product. The computer software product is stored in a storage medium and includes a plurality of instructions for enabling a computer device (which may be a personal computer, a server, or a network device) to execute all or some steps of the method according to each embodiment of the present disclosure. The foregoing storage medium includes: a USB flash disk, a read-only memory (ROM), a random access memory (RAM), a mobile hard disk, a magnetic disk, an optical disc, or other media capable of storing program code.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A power supply restoration method for a power grid cluster, comprising:
acquiring a cluster parameter of a target power grid cluster in response to a power supply fault occurred in the target power grid cluster, wherein the cluster parameter comprises at least a node voltage and a node power of each node in the target power grid cluster;
constructing a power supply restoration model corresponding to the target power grid cluster based on the cluster parameter, and solving the power supply restoration model to obtain an initial power supply restoration strategy;
reconstructing the initial power supply restoration strategy based on an alternating direction method of multipliers to obtain a target power supply restoration strategy; and
handling the power supply fault of the target power grid cluster to recover power supply based on the target power supply restoration strategy;
wherein the reconstructing the initial power supply restoration strategy based on the alternating direction method of multipliers to obtain the target power supply restoration strategy comprises:
relaxing the initial power supply restoration strategy based on a relaxation model to obtain a relaxation result; and
performing integer process on the relaxation result based on an integer function to obtain the target power supply restoration strategy.

2. The power supply restoration method according to claim 1, wherein the node power comprises an active power and a reactive power; and the constructing the power supply restoration model corresponding to the target power grid cluster based on the cluster parameter comprises:
constructing a distribution network linear power flow model based on the node voltage, the active power, and the reactive power, wherein the distribution network linear power flow model is configured to balance a voltage and a power on a circuit during a power supply restoration process; and
constructing the power supply restoration model based on the distribution network linear power flow model.

3. The power supply restoration method according to claim 1, wherein the power supply restoration model comprises an objective equation and a constraint; the objective equation is configured to express a maximum load restoration amount of the target power grid cluster; the constraint is configured to control a voltage magnitude of each node in the target power grid cluster; and the solving the power supply restoration model to obtain the initial power supply restoration strategy comprises:
solving the objective equation based on the constraint to obtain the initial power supply restoration strategy.

4. The power supply restoration method according to claim 1, wherein the relaxing the initial power supply restoration strategy based on the relaxation model to obtain the relaxation result comprises:
initializing a common variable and a multiplier of the relaxation model;
solving the relaxation model based on the initial power supply strategy to obtain a model solution value;
continuously solving, when the model solution value does not meet a first convergence condition, the relaxation model until the model solution value meets the first convergence condition, wherein the first convergence condition is configured to indicate that when the power supply restoration strategy is solved based on the relaxation model, a first primal residual is less than a first threshold and a first dual residual is less than a second threshold; and
determining, when the model solution value meets the first convergence condition, the model solution value as the relaxation result.

5. The power supply restoration method according to claim 1, wherein the performing integer process on the relaxation result based on the integer function to obtain the target power supply restoration strategy comprises:
processing the relaxation result based on the integer function to obtain an integer result;
continuously processing, when the integer result does not meet a second convergence condition, the relaxation result based on the integer function until the integer result meets the second convergence condition, wherein the second convergence condition is configured to indicate that when the relaxation result is processed based on the integer function, a second primal residual is less than a third threshold and a second dual residual is less than a fourth threshold; and
determining, when the integer result meets the second convergence condition, the integer result as the target power supply restoration strategy.

6. The power supply restoration method according to claim 1, further comprising:
performing network decomposition on a boundary node of a power grid cluster with a power supply fault through a node tearing method to obtain a virtual node; and
adding the virtual node to the power grid cluster with the power supply fault to obtain the target power grid cluster.
